(19) United States
(12) Patent Application Publication
(10) Pub. No.: US 2020/0362609 A1
(43) Pub. Date: Nov. 19, 2020

(54) LIGATURE RESISTANT DOOR AND DOOR FRAME ASSEMBLY

(71) Applicant: Accurate Door & Hardware, Inc., Totowa, NJ (US)

(72) Inventor: Richard Cornetto, Wayne, NJ (US)

(73) Assignee: Accurate Door & Hardware, Inc., Totowa, NJ (US)

(21) Appl. No.: 16/410,205

(22) Filed: May 13, 2019

(51) Int. Cl. E05D 7/081; E05D 3/06

(52) U.S. Cl. CPC E05D 7/081; E05Y 2600/41; E05Y 2900/132; E05D 3/06

(57) ABSTRACT

Provided is a ligature resistant door and door frame assembly. Such assembly enables movement of the door relative to the frame via an actuator concealed and supported by the door frame so as to eliminate conventional hinge and closer arm constructions. In doing so, the assembly eliminates such conventional structure providing potential structure capable of supporting suspension of ligature, and reduces costs associated with purchase and installation.

### FIELD OF THE DISCLOSURE

Disclosed embodiments relate to a door and door frame assembly, and more specifically, to such an assembly for decreasing susceptibility to use of ligature associated with acts of personal injury or death.

### BACKGROUND

In an increasingly more complex society having attendant demands and expectations, recent studies show an increasing rate of suicide accomplished by various methodology. One of these methods includes strangulation by a ligature, such as a rope, belt, or other length of flexible material. In particular, such method is enabled by suspension of the ligature from a fixed structure often including a door, a door handle, and a door hinge. Because of this, the number of environments prone to using these devices are myriad such that they include hospitals, mental health facilities, other government facilities and private residences. In sum, any structure having a hinged door, or any other type of door with portions protruding therefrom, which is used to enclose a space intended to be private even for a short period of time provides an opportunity for the aforementioned suspension. For example, a study reported in 2018 and appearing in Volume 44, Issue 11 of The Joint Commission Journal on Quality and Patient Safety entitled, “Incidence and Method of Suicide in Hospitals in the United States,” discusses suspension occurring in various facility spaces, including patient rooms and closets.

In an effort to address the ability to use a door and associated structure as a means to suspend a ligature, various constructions have been contemplated. For example, these include alarming the door to provide an alert regarding the application of a force on the door as well as manipulating the overall door construction by incorporating baffles/spacers between components of the door and its surrounding frame in order to assertedly remove opportunity for suspension of a ligature.

In either case, any of these constructions, and ones similar to them, unnecessarily complicate prevention of ligature suspension by giving rise to at the following drawbacks.

First, such constructions add unnecessary componentry to the door/frame assembly. As a result, opportunity for suspension may be increased due to potential malfunction of the added components, which may include their breakage and/or misplacement as the door is moved between available positions.

Second, such constructions potentially inhibit use in varied environments. For instance, existing door frames and/or surrounding structure may preclude incorporation, and thus nullify a respectively intended effect.

Third, such constructions unduly increase the purchase and/or installation cost(s) to be incurred by a user, such as, for example, a hospital. Because of this, resources needed to address other user needs may be imposed upon or depleted. An example of one such construction providing for the above drawbacks may be seen in GB 2515393. There, a door assembly is disclosed in which multiple frame components are required to conceal points within the construction that would provide opportunity for ligature suspension. In particular, such door assembly is a multi-component, multi-connection assembly that provides for a pivotally hinged door requiring overhead coverings such as a top jamb or transom. Relative to its top hinge point, the assembly further requires baffles/spacers to occlude gaps with respect to the door frame that would be available to assist in ligature suspension. Even more, the assembly uses a series of alignment portions which need to be fitted appropriately to enable hinged movement of the door throughout its double-swing disposition.

In these ways, the assembly of GB 2515393 and its multi-component, multi-connection construction preclude both (a) an ability for the same to be easily incorporated with a standardized door frame assembly due to the necessity for interaction among the variously required components, as well (b) an ease of incorporation of an ligature alarm device since incorporation of the same would likely disturb the integrity of intended assembly. Additionally, due to the opportunity for failure of the baffles/spacers, potential for fire-rating of the assembly may be hampered or eliminated.

In view of the above, it would be desirable to provide a door and/or door frame assembly that reduces an opportunity for ligature suspension in a manner that avoids at least the above-discussed drawbacks.

More specifically, it would be desirable to provide such an assembly that optimizes a construction therefor by minimizing and concealing a number of assembly components which might, otherwise, provide potential ligature suspension points. In doing so, it would further be desirable to provide such assembly as a pre-hung construction so that it may be easily adapted for use with existing door openings by, at least, optimizing applicable tolerances, and reducing a purchase and/or installation cost therefor.

### SUMMARY

It is to be understood that both the following summary and the detailed description are exemplary and explanatory and are intended to provide further explanation of the present embodiments as claimed. Neither the summary nor the description that follows is intended to define or limit the scope of the present embodiments to the particular features mentioned in the summary or in the description. Rather, the scope of the present embodiments is defined by the appended claims.

An aspect of the embodiments includes an assembly having a door, a door frame configured to receive the door for pivotal mounting with the door frame, and an actuator configured to (a) pivotally move the door with respect to the door frame, and (b) be supportably disposed within the door frame.

Another aspect of the embodiments includes an assembly having a door, a door frame configured to receive the door for pivotal mounting with the door frame, and an actuator configured to pivotally move the door with respect to the door frame, the door frame being configured to support the actuator atop a surface of the door frame.

A further aspect of the embodiments includes a door frame assembly having a door frame configured to receive a door for pivotal mounting with the door frame, and a door actuator supported by the door frame.

In certain embodiments, the disclosed embodiments may include one or more of the features described herein.

### BRIEF DESCRIPTION OF THE DRAWINGS

The accompanying drawings, which are incorporated herein and form a part of the specification, illustrate exemplary embodiments and, together with the description, further serve to enable a person skilled in the pertinent art to make and use these embodiments and others that will be apparent to those skilled in the art. Embodiments herein will be more particularly described in conjunction with the following drawings wherein:

FIG. 1 is a side perspective view of the door and door frame assembly according to embodiments disclosed herein;

FIG. 2 is a side perspective view of the door and door frame of the assembly according to FIG. 1, in which the door is shown in an open position;

FIG. 3 is a side perspective view of the door and door frame of FIG. 1, in which the door is illustrated in an opened position to 90° relative to the door frame;

FIG. 4 is a perspective view of the door and door frame of FIG. 1, in which the door is illustrated in a closed position;

FIG. 5 is an exploded view of the door assembly door relative to respective door assembly mountings;

FIG. 6 is a plan view of the door and door frame according to FIG. 1;

FIG. 7 is a side perspective view of the door and door frame according to FIG. 1, which illustrates connection between the door and the door frame at a top portion of the door;

FIG. 8 is a side perspective view of the door and door frame according to FIG. 1, which illustrates connection of the door to a bottom mounting relative to the door frame; FIG. 9 is an illustration of a door actuator of the assembly according to FIG. 1;

FIG. 10 is an illustration of an exemplary door handle configured for use with the assembly of FIG. 1; and

FIG. 11 is an illustration of an exemplary push bar configured for use with the assembly of FIG. 1.

### DETAILED DESCRIPTION

The present disclosure will now be described in terms of various exemplary embodiments. This specification discloses one or more embodiments that incorporate features of the present embodiments. The embodiment(s) described, and references in the specification to “one embodiment”, “an embodiment”, “an example embodiment”, etc., indicate that the embodiment(s) described may include a particular feature, structure, or characteristic. Such phrases are not necessarily referring to the same embodiment. The skilled artisan will appreciate that a particular feature, structure, or characteristic described in connection with one embodiment is not necessarily limited to that embodiment but typically has relevance and applicability to one or more other embodiments.

In the several figures, like reference numerals may be used for like elements having like functions even in different drawings. The embodiments described, and their detailed construction and elements, are merely provided to assist in a comprehensive understanding of the present embodiments. Thus, it is apparent that the present embodiments can be carried out in a variety of ways, and does not require any of the specific features described herein. Also, well-known functions or constructions are not described in detail since they would obscure the present embodiments with unnecessary detail.

The description is not to be taken in a limiting sense, but is made merely for the purpose of illustrating the general principles of the present embodiments, since the scope of the present embodiments are best defined by the appended claims.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items. As used herein, the singular forms “a”, “an” and “the” are intended to include the plural forms as well, unless the context clearly indicates otherwise.

The word “exemplary” is used herein to mean “serving as an example, instance, or illustration.” Any embodiment described herein as “exemplary” is not necessarily to be construed as preferred or advantageous over other embodiments. Additionally, all embodiments described herein should be considered exemplary unless otherwise stated.

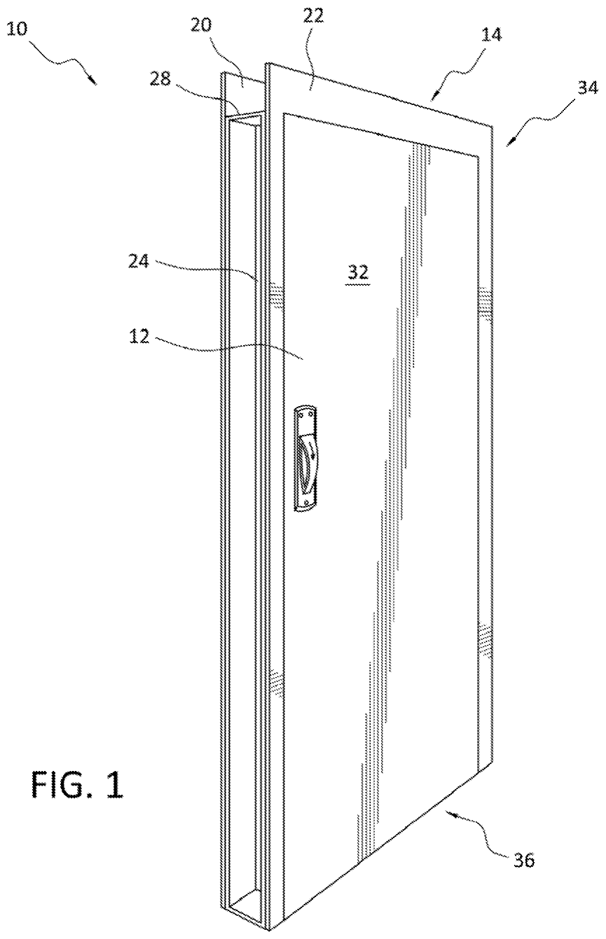

Referring to FIGS. 1, 2, and 5 there is illustrated an integrated door and door frame assembly 10 according to present embodiments which may be adapted for use in any number of exemplary environments, including hospitals, office buildings, and personal residences, to name a few. As shown, the assembly 10 comprises a door 12 (with included door handle), a door frame 14, an actuator 16, and a door bottom mounting 18. The door 12 is preferably constructed of metal, such as aluminum or steel so as to assist in fire-rating thereof. The door frame 14 preferably comprises a one-piece metal construction and defines a pair of opposed casings 20, 22. Interposed between the casings 20, 22 are side jambs 24, 26 and a header 28. As will be understood, the door 12, the door frame 14, and the actuator 16 comprise a pre-hung construction that avoids the multi-component, multi-connection required assembly of, for instance, GB 2515393 which is discussed above.

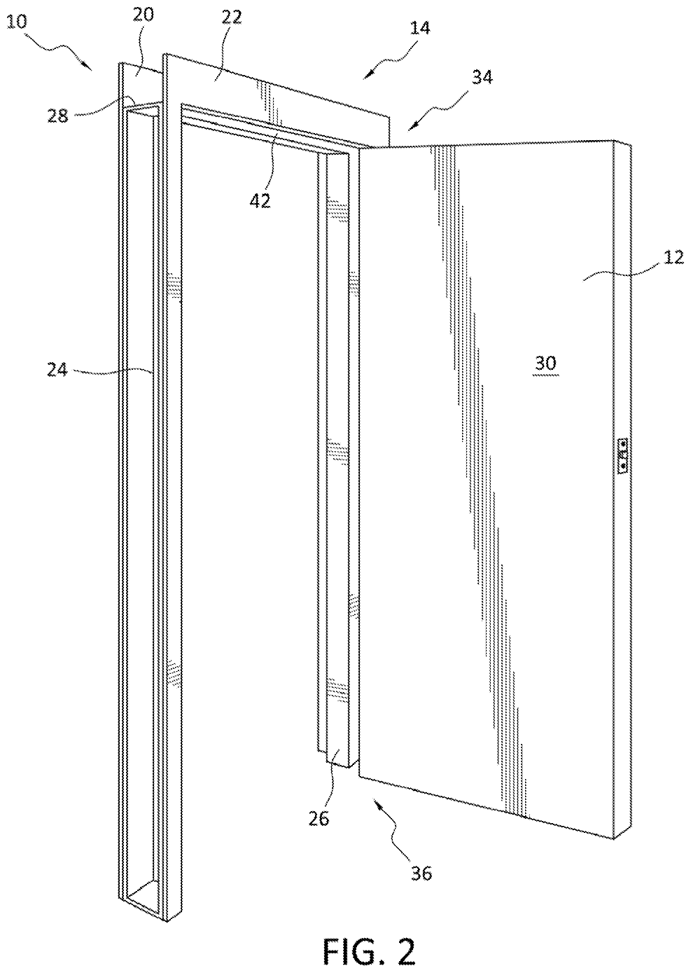

In looking more specifically at FIG. 2, the door 12 is shown is an opened position exposing a backside 30 thereof (opposing a frontside 32 shown in FIG. 1), and in which the door 12 is extended outwardly to approximately 90° relative to the door frame 14. As will be discussed later, the door 12 is configured to be pivoted at its top 34 and bottom 36 relative to the door frame 14 to achieve its open position.

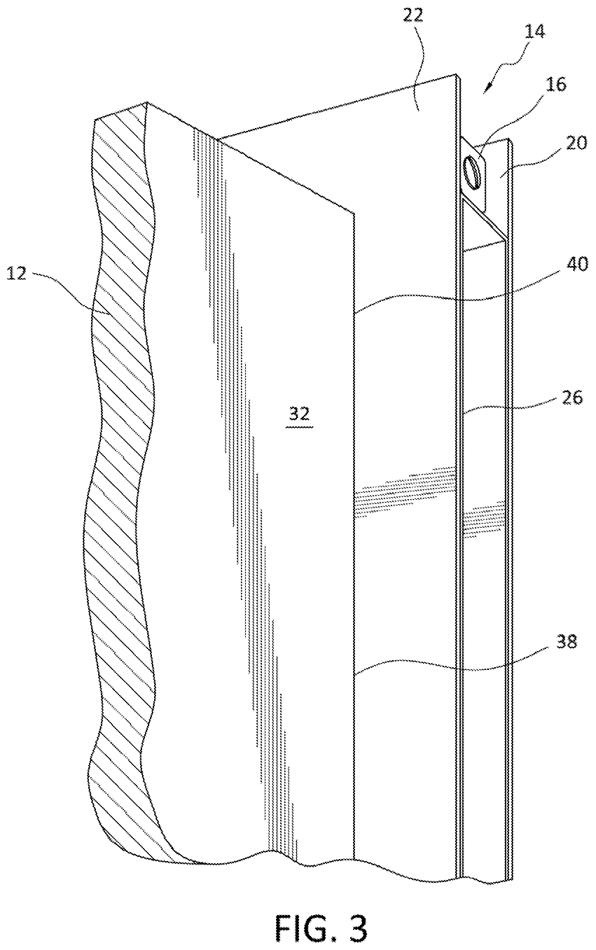

With reference to FIG. 3, a gap 38 between the side jamb 26 and a peripheral edge 40 the door 12 is minimized (as discussed below) so as to prevent passage of items therethrough that might either (a) impede movement of the door 12 or (b) be passed between the door 12 and the side jamb 26 and held (by closure of the door 12) as a means of ligature suspension.

In referring to FIGS. 2 and 7, the header 28 defines a downwardly extending stop 42 against which the door 12 abuts when in its closed position.

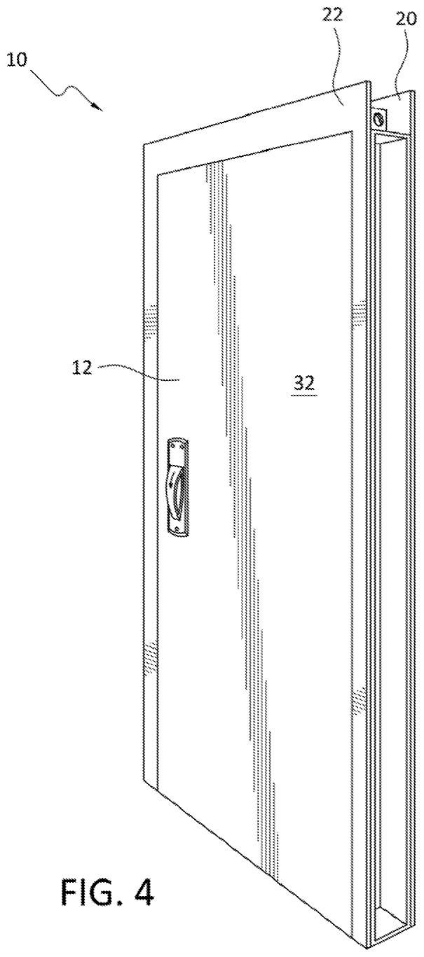

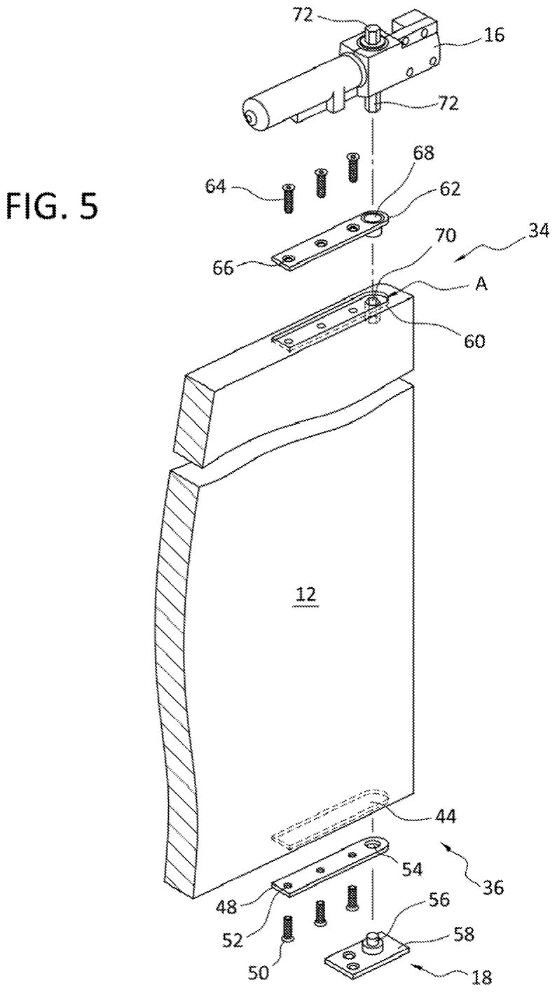

Referring to FIG. 5, there is illustrated a detail of the door 12 of the door assembly 10. As shown, the bottom 36 of the door 12 comprises a bottom cavity 44 for cooperation with the door bottom mounting 18. The mounting 18 comprises a bottom mounting bracket 48 for placement within the bottom cavity 44 and affixation to the door 12 via screws 50, or other similar type fasteners, inserted through apertures 52. The bottom mounting bracket 48 comprises an end aperture 54 configured to receive an upwardly disposed spindle 56 defined by a floor mount 58 forming part of the door bottom mounting 18. As such, the spindle 56 defines a bottom or first pivot portion for the door 12 relative to the door frame 14. At the top 34 of the door 12, there is defined a top cavity 60 for cooperation with a top mounting bracket 62 which is mountable with the door 12 via screws 64, or other similar type fasteners, inserted through apertures 66 which are aligned with apertures defined by top cavity 60. Top mounting bracket 62 further defines an end aperture 68 and downwardly extending guide which is off-centered with respect to a midpoint of the bracket 62. Before the top mounting bracket 62 is installed with the door 12, a pivot portion, discussed below and defined by the actuator 16, is passed through the end aperture 68, whereupon subsequent securement of the top mounting bracket 62 and its aperture 68 guide to the door 12 will then seat the pivot portion with respect to an aperture 68 guide receiving portion and within a hexagonally contoured pivot receiving chamber 70 formed in the door 12 at “A.” As will be understood, pivot portion and pivot receiving chamber 70 may be similarly configured so as to enable actuator 16 to transmit an actuating force from the actuator 16 to the door 12. As a result, the door 12 may accomplish an automatic, self-closing to achieve at least the closed position shown in FIG. 4, as well a number of intermediary positions between the open and closed positions.

In particular, the actuator 16 shown in FIG. 5, as well as in FIG. 9, may comprise a 4030T series closer cylinder assembly manufactured by LCN, which features a rack and pinion, spring-biased construction enabling torque to be applied to an actuator pin 72 forming part of the pinion. In these regards, the actuator pin 72 is constructed to extend upwardly from the actuator body, as well as downwardly therefrom in the direction of the pivot receiving chamber 70, whereas the downward extension of the actuator pin 72 forms a second pivot portion for the door 12. Thus, as will be understood, as a push/pull force is exerted on the door 12 to open the door 12, the actuator 16 will be exercised to compress its internally housed spring whereupon release of such a force will trigger expansion of the spring and resulting transmission of torque from the actuator pin 72 and then to the door 12 to actuate movement of the door 12 to the closed position shown in FIG. 4. Optionally, the door 12 may be equipped with an automatic latching mechanism for fire-rating purposes, whereupon the release of such mechanism will enable opening of the door 12 and subsequent operation of the actuator 16 (when the push/pull force is absent) to enable automatic, self-closing movement of the door 12 to its closed position relative to the door frame 16. In these respects, any latching mechanism having an active latch bolt will suffice.

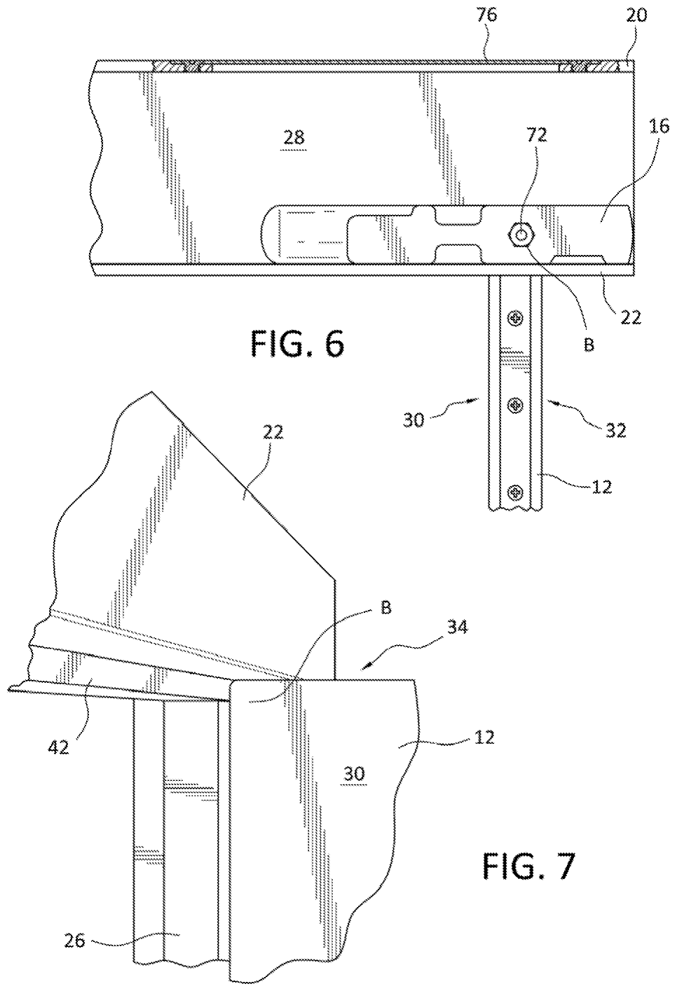

Now referring to FIG. 6, the mounting of the actuator 16 with the door 12 and the door frame 14, and specifically with the header 28 of the door frame 14, is shown. As will be understood with additional reference to FIG. 3, the actuator 16 sits atop the header 28 and between the casings 20, 22. More particularly, the actuator 16 is disposed so as to not extend beyond ends of the casings 20, 22. In this way, when the door and door frame assembly 10 is installed relative to surrounding wall structure defining an existing wall opening, the actuator 16 is entirely concealed. As such, no portion of the actuator 16, owing to its placement atop the header 28 and between the casings 20, 22, is exposed and vulnerable to assist with ligature suspension.

As will be further understood with reference to FIGS. 5 and 6, the actuator pin 72 is fitted through an aperture (not shown) in header 28 so as to be received through the end aperture 68 for retention within the pivot receiving chamber 70 of the door 12. In this regard, the actuator pin 72 is hexagonally configured so as to match a configuration of pivot receiving chamber 70 so that the actuator pin 72 is snugly fit within said chamber 70. Thus, as the actuator 16 is exercised in response to application of the door opening force on the door 12, the door 12 may be opened and will self-close in response to a release of said force (as a result of expansion of the spring inside the actuator 16).

In referring to FIGS. 5, 6, and 7, actuator pin 72 is disposed through the door frame 14 and into the door 12 so as to be off-centered at “B” with respect to a midpoint of top mounting bracket 62, such that actuator pin 72 is, when seated with the door 12, disposed most proximate a right side end edge (adjacent casing 22), as opposed to a left side end edge (adjacent casing 20), of header 28 (see FIG. 6). For example, in a preferred embodiment, actuator pin 72 may be disposed through end aperture 68 and into pivot receiving chamber 70 such that a center of actuator pin 72 lays 0.625 inches from an edge of top mounting bracket 62, wherein bracket 62 is most proximate the right side end edge of header 28 adjacent casing 22 (see FIG. 6). In this way, such disposition of actuator pin 72 aligns with the bottom spindle 56 of the door bottom mounting 46 so as to enable, with reference to FIG. 3, a pivoting of the door 12 from the peripheral edge 40 of the door 12 towards the header stop 42 to enable a substantially flush engagement of the door 12 with the header stop 42 and jamb 26. As a result, gap 38, as shown in FIG. 3, is minimized and/or substantially eliminated. Additionally, a gap between the door 12 and the header stop 42 which would otherwise result if actuator pin 72 were (a) disposed away from the right side edge of header 28 and at, for example, a center of top mounting bracket 62 and (b) correspondingly aligned with bottom spindle 56, is also avoided. An advantage of avoiding such aforementioned gaps rests in assisting fire-rating of the integrated door 12 (with included pull handle/push bar) and the door frame 14 due to the aforementioned engagements. Further advantages of the off-centered disposition of actuator pin 72 and its alignment with bottom spindle 56 include, at least, (a) enabling movement of the door 12 with respect to the door frame 14 to pivot to a permanent stop (to abut against stop 42, for example), as is required for fire-rating purposes, and (b) ease of use with standard door locks, latches and other door retention devices which are commonly used to resist push or pull forces on non-fire-rated doors and smoke doors.

Also shown with reference to FIG. 7 and opposite the juncture “B,” is an accessible compartment door 76 defined by the door frame 14 casing 20 for exposing the actuator 16 once the door assembly 10 is fully installed relative to surrounding wall structure. As will be understood, door 76 may be removed/attached via adjustment of the shown fasteners. With such accessibility, the actuator 16 may be maintained or otherwise removed via release of the top mounting bracket fasteners 64 and movement upwardly from the pivot receiving chamber 70.

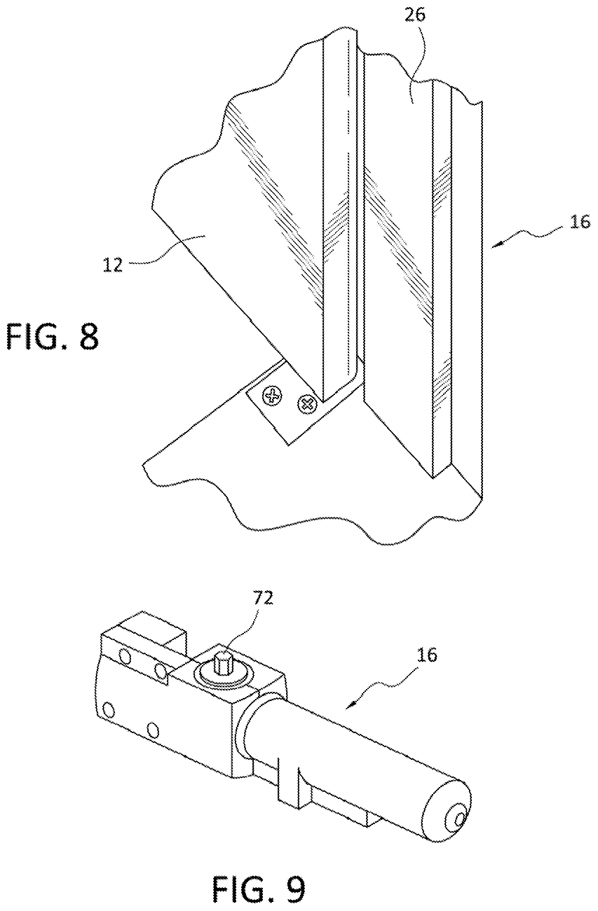

FIG. 8 illustrates the mounting of the door 12 with the door frame 16 so as to provide an alignment of the bottom spindle 56 with the actuator pin 72 for enabling the substantially flush engagement of the door 12 with the header stop 42 when the door 12 is in a fully closed position as is illustrated in FIG. 4.

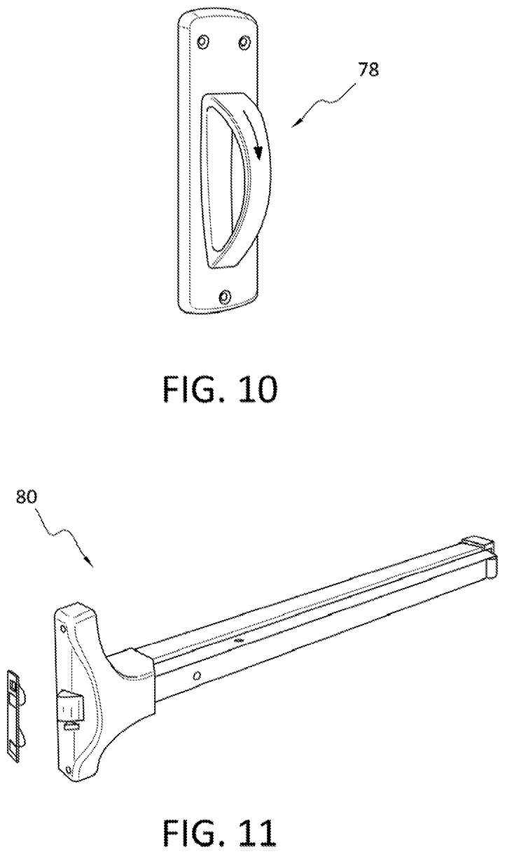

FIGS. 10 and 11 show, respectively, a handle 78 representing the handle shown on the frontside 32 of the door 12 in FIG. 1 and a push bar door and frame assembly 80 in which the push bar may be affixed to the backside 30 of the door 12. More particularly, the handle 78 is, for example, of a type defined as a CRXA-Heavy Duty Ligature Resistant Cylindrical manufactured by TOWNSTEEL, and the push bar assembly 80 is, for example, of a type defined as a YALE 2100(F) exit device which may be fixed (not shown) with the back side 30 of the door 12 to receive a push force thereon.

In view of the above, the disclosed embodiments provide for a door assembly 10 which substantially reduces and/or eliminates opportunity to ligature suspension. Such is enabled by the one-piece door frame construction which supports the actuator 16, whereby, when the door and door frame assembly 10 is installed with existing wall structure, the actuator 16 is entirely concealed therewithin the door frame 14. As will be understood, provision of the actuator 16 atop the header 28 contributes to such concealment and enables the actuator 16 to be readily supported upon the header 28 so as to preclude the actuator 16 itself from being a supporting structure for ligature suspension. In this way, the gap occlusion discussed with respect to the baffles/spacers of GB 2515393 is retained by virtue of the mounting of the actuator 16 with the header 28 as the need for such baffles/spacers is obviated due to such mounting.

As will also be understood, since the actuator 16 itself provides the aforementioned top pivot for the door 12, pivoting of the door 12 relative to the door frame 14 is achieved in a hingeless fashion and without the need for a standard closer arm ordinarily attached to the actuator 16. In this way, the absence of such hinges and closer arm further contribute not only to the elimination of supporting structure for ligature suspension, but also to a reduction in overall purchase and installation costs for the assembly 10.

The present embodiments are not limited to the particular embodiments illustrated in the drawings and described above in detail. Those skilled in the art will recognize that other arrangements could be devised. The present embodiments encompass every possible combination of the various features of each embodiment disclosed. One or more of the elements described herein with respect to various embodiments can be implemented in a more separated or integrated manner than explicitly described, or even removed or rendered as inoperable in certain cases, as is useful in accordance with a particular application While the present embodiments have been described with reference to specific illustrative embodiments, modifications and variations of the present embodiments may be constructed without departing from the spirit and scope of the present embodiments as set forth in the following claims.

Although the present embodiments have been described in detail, those skilled in the art will understand that various changes, substitutions, variations, enhancements, nuances, gradations, lesser forms, alterations, revisions, improvements and knock-offs of the embodiments disclosed herein may be made without departing from the spirit and scope of the embodiments in their broadest form.

What is claimed is:

1. An assembly, comprising:
a door;
a door frame configured to receive the door for pivotal mounting therewith;
an actuator configured to pivotally move the door with respect to the door frame, and be supportably disposed within the door frame.

2. The assembly of claim 1, wherein:
the door frame comprises a one-piece construction.

3. The assembly of claim 1, wherein:
the door and the door frame comprise a one-piece, pre-hung construction.

4. The assembly of claim 3, further comprising:
a first pivot portion for the door.

5. The assembly of claim 4, wherein:
the actuator comprises a second pivot portion for the door configured to be mounted at position opposite the first pivot portion.

6. The assembly of claim 5, wherein:
each of the first pivot portion and the second pivot portion are linearly aligned, and configured for operative connection to the door enabling pivotal movement of the door with respect to the door frame.

7. The assembly of claim 6, wherein:
the door is self-closing.

8. The assembly of claim 7, wherein:
when in a closed position, the door aligns substantially flush with the door frame.

9. An assembly, comprising:
a door;
a door frame configured to receive the door for pivotal mounting therewith;
an actuator configured to pivotally move the door with respect to the door frame, the door frame being configured to support the actuator atop a surface of the door frame.

10. The assembly of claim 9, wherein:
the door frame comprises a pair of opposed casings.

11. The assembly of claim 10, wherein:
the door frame comprises a header portion disposed between the casings.

12. The assembly of claim 11, wherein:
the door frame comprises a one-piece construction.

13. The assembly of claim 12, wherein:
the actuator is supported on the header portion.

14. The assembly of claim 13, further comprising:
a first pivot portion for the door.

15. The assembly of claim 14, wherein:
the actuator comprises a second pivot portion for the door configured to be mounted at position opposite the first pivot portion.

16. The assembly of claim 15, wherein:
each of the first pivot portion and the second pivot portion are linearly aligned, and configured for operative connection to the door enabling pivotal movement of the door with respect to the door frame.

17. A door frame assembly, comprising:
a door frame configured to receive a door for pivotal mounting therewith; and
a door actuator supported by the door frame.

18. The door frame assembly of claim 17, wherein:
the door frame comprises a pair of opposed casings disposing a header therebetween.

19. The door frame assembly of claim 18, wherein:
the actuator is supported atop the door frame.

20. The door frame assembly of claim 19, wherein:
the actuator comprises a pivot portion configured for attachment through the header and with the door to enable pivotal movement of the door with respect to the door frame.
